(19) United States
(12) Patent Application Publication
(10) Pub. No.: US 2008/0052403 A1
(43) Pub. Date: Feb. 28, 2008

(54) INPUT/OUTPUT ROUTERS WITH DUAL INTERNAL PORTS

(75) Inventors: John Acton, Danville, CA (US); Charles Binford, Wichita, KS (US); Daniel R. Cassiday, Topsfield, MA (US); Raymond J. Lanza, Nashua, NH (US); Andrew W. Wilson, Fremont, CA (US)

Correspondence Address: HOGAN & HARTSON LLP, ONE TABOR CENTER, SUITE 1500, 1200 SEVENTEEN ST., DENVER, CO, 80202, US

(73) Assignee: SUN MICROSYSTEMS, INC., Santa Clara, CA (US)

(21) Appl. No.: 11/466,729

(22) Filed: Aug. 23, 2006

(51) Int. Cl. G06F 15/16; G06F 11/00

(52) U.S. Cl. 709/230; 710/1; 714/100

(57) ABSTRACT

Dual ported Input/Output (“I/O”) routers couple I/O devices to a cross-coupled switching fabric providing multiple levels of data path redundancy. Each I/O router possesses two or more internal ports allowing each I/O router to access multiple switches in a cross-coupled switching fabric. The additional redundant paths between each I/O device and each microprocessor complex provide additional means to balance data traffic and thereby maximize bandwidth utilization. I/O routers can be interleaved with single HBAs establishing access a switching fabric that uses cross-coupled nontransparent ports thus providing each I/O device with multiple paths upon which to pass data. Data paths are identified by a recursive address scheme that uniquely identifies each data path option available to each I/O device.

### RELATED APPLICATIONS

The present application relates to U.S. patent application Ser. No. ______ filed on ______ entitled, “Data Buffer Allocation in a Non-blocking Data Services Platform using Input/Output Switching Fabric” and U.S. patent application Ser. No. ______ filed on ______ entitled, “Cross-Coupled Peripheral Component Interconnect Express Switch”. The entirety of both applications is hereby incorporated by this reference.

### BACKGROUND OF THE INVENTION

1. Field of the Invention

Embodiments of the present invention relate, in general, to multiple ported Input/Output (“I/O”) cards and specifically the use of dual ported I/O cards providing multiple data paths for traffic balancing.

2. Relevant Background

Typical current computer system configurations consist of one or more microprocessors and one or more Input/Output (“I/O”) complexes connected through internal high speed busses. This connection occurs via I/O adapter cards, commonly termed Host Bus Adapters (HBAs) or Network Interface Cards (NICs). Examples of I/O busses that can be used to connect the microprocessor complex to HBAs and NICs include InfiniBand and Peripheral Component Interconnect express (“PCIe”) switches, as shown in prior art FIG. 1.

Microprocessor complexes in many such systems provide several I/O busses (devices) that may either be connected directly to an HBA or connected to several HBAs through an I/O switch. As illustrated in FIG. 1, an I/O switch 110 forms a tree of devices owned by one microprocessor complex 120 at the root of the tree. The microprocessor complex 120 of FIG. 1 is connected directly to a single HBA 130 as well as the switch 110 that is in turn coupled to two other HBA devices 140, 150 and a NIC 160, the NIC 160 providing access to a network 170. Two arrays 180, 190 are also connected to the microprocessor complex 120 via the PCIe switch 110/HBA 150 path or directly through a single HBA 130 respectively.

As many computer systems, and the storage devices connected to them, are expected to maintain a very high state of availability, it is typically expected that the systems continue to run even when a component fails. The most common approach to achieving high availability is to provide redundant components and paths. For example, a system may have two microprocessor complexes, each of which can access all of the I/O devices. Should one of the microprocessors fail, the other can continue processing, allowing the applications to continue running possibly at a decreased level of performance.

Within a storage appliance, it remains necessary to have at least two independent storage processors in order to achieve high availability. In FIG. 2, two such independent storage processors 230, 240 are shown, as is known in the prior art, with two separate instances of an operating system, one running on each processor 230, 240. There is also a pair of inter-processor links 280 that provide communication between the two processors 230, 240 and can optionally include switches and additional links to other storage processors for capacity expansion. These links can be Ethernet, InfiniBand or of other designs as known in the art. The system shown in FIG. 2 allows each host 210, 220 equal access to each array 250, 260, 270 via one or both of the storage processors 230, 240 as depicted.

For a number of reasons many of the offered I/O requests and associated data may have to be processed by the two or more storage processors 230, 240 necessitating travel of data across the inter-processor links 280. This can occur with larger configurations because a given host 210, 220 and array 250, 260, 270 may not be connected to the same set of storage processors 230, 240. Even when they are, the direct link may be a secondary one, and hence, the requests will still have to travel across an inter-processor link 280. Additionally, some applications frequently modify and reference data states that can be difficult and expensive to distribute between storage processors. In such cases, only a standby copy of data states exists on other storage processors, and all requests that need that application must be forwarded over the inter-processor links to the active application instance. Requests that must visit two or more storage processors encounter additional forwarding delays, require buffer allocation in each storage processor, and can use substantial inter-processor link bandwidth.

Storage Networking protocols, such as Fibre-Channel and others, as known in the prior art, allow a number of hosts to share a number of storage devices, thus increasing configuration flexibility and potentially lowering system cost. However, in such systems intelligent switches are needed to allocate the shared storage between the hosts and allow efficient transfer of data between any storage device and any host. Such an I/O switching fabric allows data to be sent between any of the HBAs and any microprocessor complexes, and could be of any appropriate type, such as InfiniBand, PCI express, or Ethernet. One exemplary switching fabric is described in co-pending U.S. patent application Ser. No. ______ entitled “Cross-Coupled Peripheral Component Interconnect Express Switch,” the entirety of which is incorporated herein by this reference. The combination of HBAs, I/O switching Fabric, and microprocessor complexes forms an intelligent data switching system and can provide data routing and transformation services to the connected hosts.

Just as cross-coupling switches can increase capacity and provide higher availability in a FC storage network, so can cross-coupling switches within a multiprocessor system. Multistage switching allows capacity expansion by adding extra columns and rows to the switch matrix. If link bandwidth utilization is well balanced, a near linear increase in total system bandwidth can be achieved as you increase the system size, at a significant savings in switch elements over those required by a full crossbar switch.

As shown in FIG. 3, by adding a second stage (row) of switches 350 to the first stage (row) of switches 360, thus forming a switching fabric 370, a second, redundant, path can be created between each microprocessor 310 and each memory 340. These redundant paths provide the benefits of improved availability and traffic spreading. Careful examination of FIG. 3 will reveal that all combinations of any microprocessor 310 and any memory 340 has available to it two independent paths through the switch fabric 370, allowing full connectivity to continue even if one switch fails.

The existence of alternate paths between any microprocessor complex and any I/O device, while desirable, necessitates the use of routers. It is desirable, therefore, to intelligently route data traffic between a plurality of microprocessor complexes and a plurality of I/O devices when multiple paths exist between each microprocessor complex and each of the I/O devices.

### SUMMARY OF THE INVENTION

Briefly stated, embodiments of the present invention disclose multiple data paths between each of a plurality of I/O devices and a plurality of microprocessor complexes. Dual ported I/O routers couple I/O devices to a cross-coupled switching fabric to provide multiple levels of path redundancy. Each I/O router possesses two or more ports allowing each I/O router to access multiple switches in a cross-coupled switching fabric. The additional redundant paths between each I/O device and each microprocessor complex provide additional means to balance data traffic and thereby maximize bandwidth utilization. In one embodiment of the present invention, I/O routers access a switching fabric that uses cross-coupled peripheral component interconnect nontransparent ports providing each I/O device with multiple paths upon which to pass data.

Each path between an I/O device and a particular microprocessor complex is identified by a route map formed by a recursive address scheme that maps all of the available data paths between each I/O device and each microprocessor complex. The selection of the particular path to be utilized is, in one embodiment, based on balancing data flow while in another embodiment the selection of the data paths is random.

The features and advantages described in this disclosure and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 shows a simple interconnect tree between a plurality of I/O devices and a single microprocessor complex as is known in the prior art;

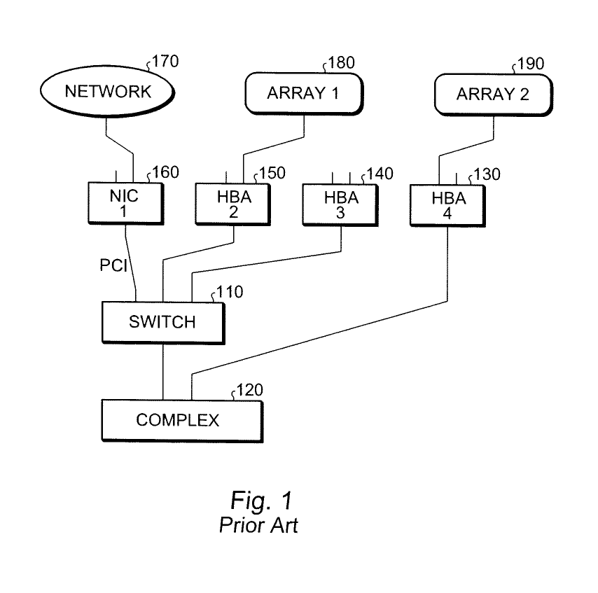

FIG. 2 shows storage processor appliance architecture with a plurality of I/O devices (arrays) and multiple hosts as is known in the prior art;

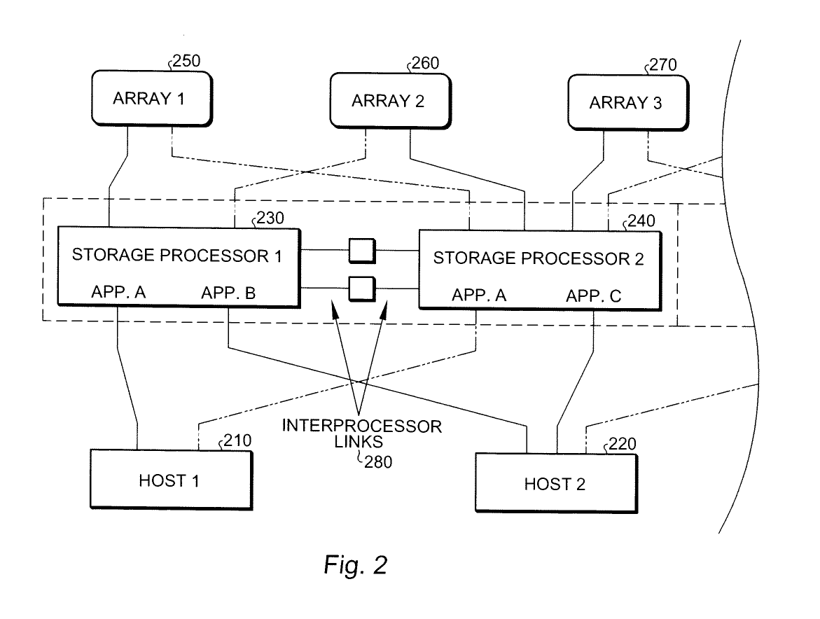

FIG. 3 shows a redundant high availability storage array using a switching fabric coupling a plurality of storage arrays and a plurality of microprocessor complexes as is known in the prior art;

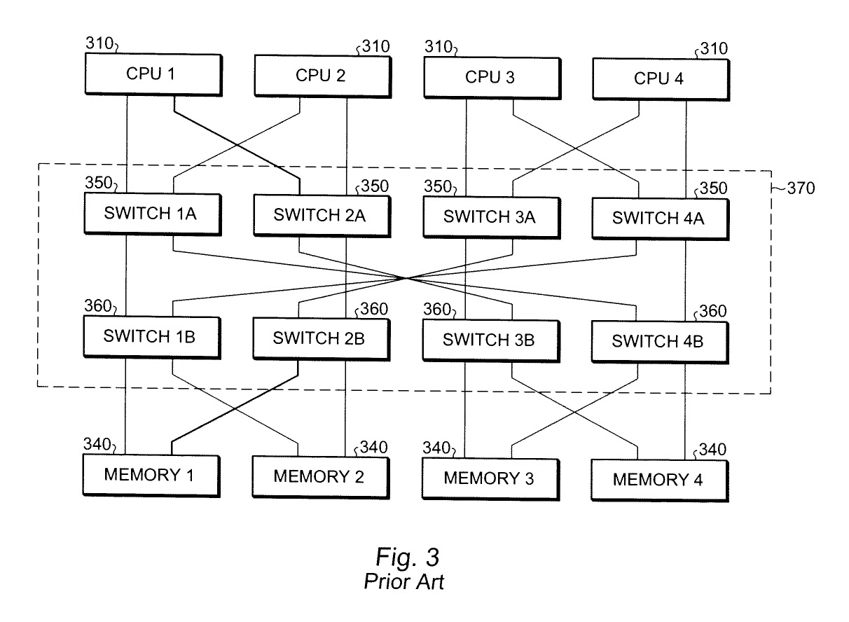

FIG. 4 shows a high level block diagram of a switching fabric having I/O routers for providing a plurality of data paths between some I/O device and each microprocessor complex using a cross-coupled switching fabric and multiple ported I/O routers, according to one embodiment of the present invention;

FIG. 5 is a high level block diagram for a system for separating data content from data control among a plurality of microprocessor complexes, according to one embodiment of the present invention and

FIG. 6 is a flow chart of one method embodiment for providing multiple data paths between a plurality of I/O devices and a plurality of microprocessor complexes using a cross-coupled switching fabric and multiple ported I/O routers, according to the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

Dual ported I/O cards (also referred to herein as I/O routers) couple I/O devices to a cross-coupled switching fabric to provide multiple levels of path redundancy. Each I/O router possesses two or more internal ports allowing each I/O router to access multiple switches in a cross-coupled switching fabric. I/O cards, routers, possess ports on both the front and back side of the card. Traditionally I/O cards, as is well known in the art, will have between 2 and 8 ports on the front side of the card for connecting the card to I/O devices but only a single port on the back side of the I/O card. According to one embodiment of the present invention, I/O routers of the present invention possess two or more back end, or internal ports so as to provide additional redundant paths between each I/O device and each microprocessor complex thus supplying additional means to balance data traffic and thereby maximize bandwidth utilization. Hereinafter, I/O routers referred to in this detailed description are those I/O cards comprising two or more back end or back side ports. In one embodiment of the present invention, I/O routers using a plurality of back end ports accesses a switching fabric that uses cross-coupled nontransparent ports providing each I/O device with multiple paths upon which to pass data.

One embodiment of the present invention utilizes I/O routers that can themselves determine what virtualization services are needed and thereafter send the control portion of a data transfer to the microprocessor complex on which that service is running. Simultaneously, I/O routers can select a (possibly different) microprocessor complex to store the data in a local buffer. Thus data control can be passed to the appropriate microprocessor complex without first visiting the microprocessor owning the I/O router independent of the storage location of the data.

Control of what path is selected between any I/O device and any particular microprocessor complex rests with the microprocessor complex connected to the I/O device via the transparent port on a switch. Note that data can be sent over any port (i.e. path) of the I/O router. In one embodiment of the present invention, each port of an I/O router is connected to a different switch. The I/O router can continue to function to deliver data to the designated microprocessor complex even when one of the switches coupled to the I/O router fails. In another embodiment the I/O router is not only connected to a functioning switch of the switching fabric, but, should the utilized switch employ a nontransparent port or ports to allow connection to between all microprocessor complexes as is described in co-pending U.S. patent application Ser. No. ______ entitled “Cross-Coupled Peripheral Component Interconnect Express Switch,” the I/O router can maintain connectivity to all microprocessor complexes even in the event of individual switch failure with minimal performance degradation.

For example, when a dual ported router is connected to a cross-coupled switching fabric and the cross-coupled switching fabric is connected to a microprocessor complex having two or more microprocessors, the data for each I/O transaction traveling from one I/O device to a second I/O device will have many possible routes. The sending I/O device via a dual ported router has available to it two possible switches. Due to the cross coupling of switches, each switch has itself access to two microprocessors providing a total of four routes. From the microprocessor that the transaction landed there exists paths to two switches again having at least two paths to an I/O router coupled to the destination I/O device. By adding additional microprocessors the number of possible paths can increase substantially. Any of these routes can be selected to balance data traffic as well as serve as redundant paths should any component on a primary or selected path fail.

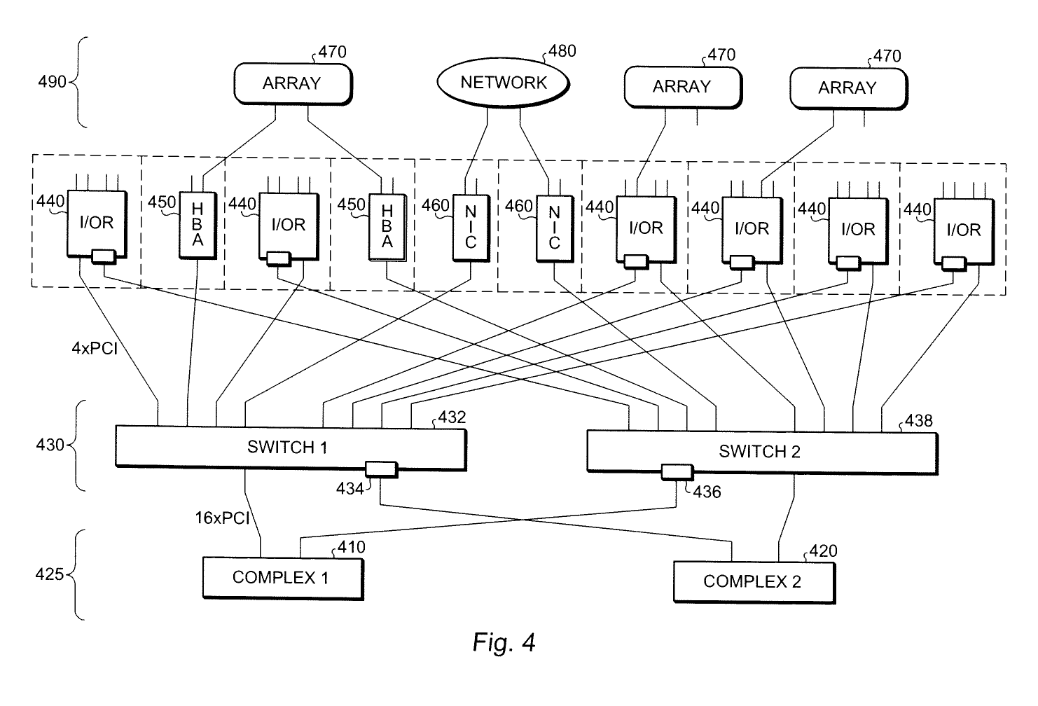

FIG. 4 shows one embodiment of a switching fabric having I/O routers for providing a plurality of data paths between each I/O device and each microprocessor complex using a cross-coupled switching fabric and multiple ported I/O routers, according to one embodiment of the present invention. A plurality of I/O devices 490 are coupled to a plurality of microprocessor complexes 425 via a switching fabric 430 and a plurality of HBAs 450, NICs 460, and I/O routers 440. While the exemplary embodiment shown in FIG. 4 couples a network 480 and a plurality of arrays 470 to a microprocessor complex 425, one skilled in the art will appreciate that the present invention is equally applicable to other types of I/O devices that facilitates to the movement of data.

According to one embodiment of the present invention, each of a plurality of I/O devices 490 has at its disposal multiple paths by which to reach any microprocessor complex 425. Each I/O device 490 is coupled to the switching fabric 430 via an interface. The interface can be in the form of a single ported HBA 450, a NIC 460 or an I/O router. According to one embodiment each I/O device 490, such as the depicted arrays 470, are provided with multiple paths to access the switching fabric 430. In this depiction, each array 470 can be coupled to the switching fabric 430 via a dual ported I/O router 440. As one skilled in the art can appreciate, an I/O router 440 with additional ports can be also utilized thus allowing the present invention to be scaled accordingly.

Each I/O router 440 shown in FIG. 4 provides its associated array 470 with at least two paths by which to be coupled to the switching fabric 430. According to one embodiment of the present invention, the I/O router 440 couples the array 470 (I/O device) to different switches 432, 438. In this simplified representation of the present invention, each array 470 can reach either microprocessor complex 410, 420 regardless of the failure of one of the switches 432, 438 in the switching fabric 430.

Likewise a network connection 480 through multiple NICs 460 can again provide multiple data paths. Each NIC 460 possesses a single port by which it can couple the network 480 to the switching fabric 430. In the embodiment shown in FIG. 4, two NICs 460 interface with the Network 480 and the switching fabric 430, each through unique switches 432, 438. Significantly, the single ported NIC 460 and the dual ported I/O routers 440 can exist on the same chassis and/or be interleaved without detrimentally impacting the flow of data though the system.

In the like manner, an array 470 can also achieve the same level of path reliability by being coupled to the switching fabric 430 through two single ported HBAs 450. Again the array 470 has two possible paths by which to interface with the switching fabric 430 at unique points of entry, i.e. unique switches 432, 438.

The switching fabric 430 is also cross-coupled as shown in FIG. 4. In one embodiment of the present invention, peripheral component interconnect express switches 432, 438, cross-coupled via at least one non-transparent port 434, 436, comprise the switching fabric 430. Other switches, as known to one skilled in the art, can be used without departing from the intent and scope of the present invention. Each switch 432, 438 possesses a non-transparent port that is used to cross-coupled the switches forming a switching fabric 430. In the embodiment shown in FIG. 4, only two switches 432, 438 are present thus each switch is cross-couple to the other's owning microprocessor complex 420, 410. As will be appreciated by one skilled in the art, the switching fabric 430 can be scaled to accommodate additional I/O devices 490 and additional microprocessor complexes 425. As the number of switches grow, the switches themselves are cross-coupled together. In the embodiment shown in FIG. 4, the switches 432, 438 are cross-coupled using non-transparent ports.

As each I/O device 490 possesses multiple data paths at its disposal, the selection of what path is used must be managed. In one embodiment the microprocessor owning the HBA or NIC controls what path is selected. With standard operating systems, target and initiator drivers would be placed on the microprocessor complex that owns an associated HBA to control movement of data. A request from a host would arrive to the controlling microprocessor complex and the target driver and the initiator driver within that microprocessor complex would process the request. Control information from the target driver to a virtualization service is conveyed via a SCSI server.

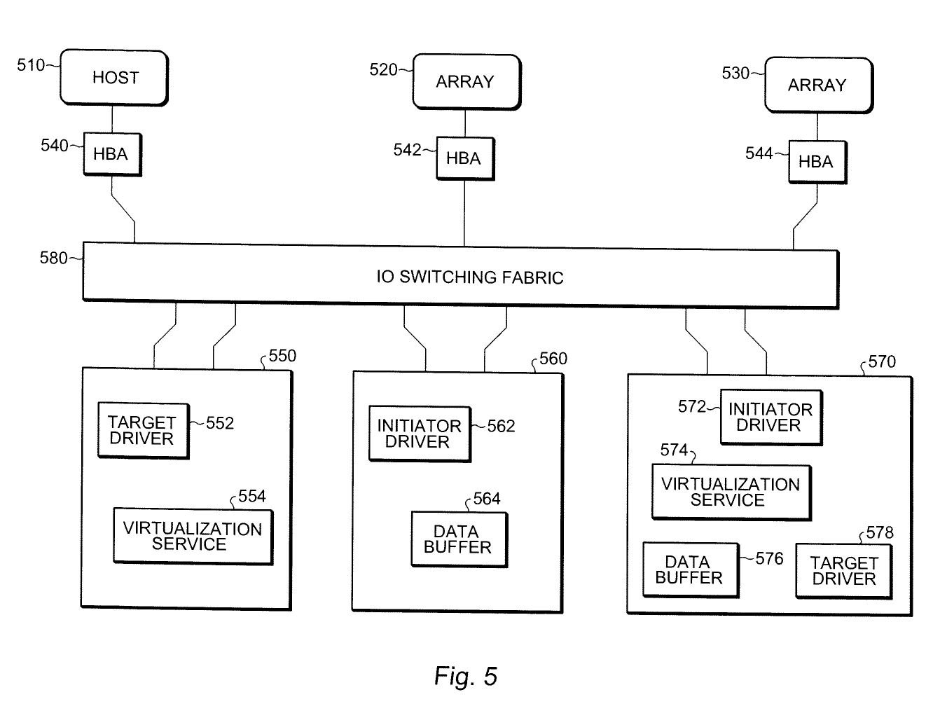

As will be appreciated by one skilled in the art, control information typically passes from an HBA to a virtualization service via a number of steps. Generally control information originating in a HBA 540, 542, 544, as shown in FIG. 5, is conveyed to a target mode driver 552 in the owning operating system domain/microprocessor complex 550 and is then passed to a SCSI server in the same complex to thereafter reside in a SCSI class driver stack 562. As will be appreciated by one skilled in the art, FIG. 5 is a high level block diagram for a system for separating data content from data control among a plurality of microprocessor complexes, as is further described in co-assigned U.S. patent application Ser. No. ______ entitled, “Data Buffer Allocation in a Non-blocking Data Services Platform using Input/Output Switching Fabric.” Transfer of control information continues through an internal fabric to a second operating system domain/microprocessor complex 570 where it is directed to a SCSI class target driver 578 and SCSI server instance found in the second microprocessor complex 570. Finally the control information arrives at the virtualization service 574 in the second microprocessor complex 570. Meanwhile, data associated with the above mentioned control information flows from the same HBA 540, 542, 544 to the first microprocessor complex 550 through the actions of the SCSI server and the target mode driver 552 of that microprocessor complex 550. Thereafter the data flows from the first to a second microprocessor complex 560, 570 through the internal fabric and through actions of the SCSI class drivers 562, 572 and the SCSI server instance on the second microprocessor complex 560, 570.

According to one embodiment of the present invention, the passing of control information can be simplified by using a Remote Procedure Call (RPC) mechanism associated with I/O routers in place of the SCSI class drivers and a second use of SCSI server. Using such a mechanism, control information can be passed by using the SCSI server virtualization service on the first microprocessor complex and then calling directly to the additional virtualization service on the second microprocessor complex. Alternatively and according to another embodiment of the present invention, the target mode driver can determine what microprocessor complex to use, and go directly to the SCSI server on the second microprocessor complex. In yet another embodiment and as illustrated in FIG. 4, intelligent I/O routers, can send the control information directly to the second microprocessor complex where the SCSI server and virtualization service reside, without communicating with the first complex at all. These methods of data flow aid in achieving optimal bandwidth efficiency.

In other embodiments of the present invention, a data balancing manager communicates with each microprocessor complex to manage the data flow between the I/O devices and the microprocessor complexes based on balancing the data flow between each microprocessor complex. In another embodiment of the present invention, path selection is random. As will be appreciated by one skilled in the art, other data balancing routines may be invoked without departing from the intent and scope of the present invention. These and other implementation methodologies an be successfully utilized by the present invention. These implementation methodologies are known within the art and the specifics of their application within the context of the present invention will be readily apparent to one of ordinary skill in the relevant art in light of this specification.

In another embodiment of the present invention, an address scheme is established to provide each I/O device with a static address map of destination microprocessor complexes. For example, one particular I/O device, coupled to an I/O router, may select from a menu of 8 different data paths so as to reach a desired microprocessor complex.

A simple address routing associated with a single stage switching complex is extended to a multi-stage switch through a recursive application of address based routing. The steps to construct these address mappings proceeds from the microprocessor complexes themselves up through the switching fabric and I/O routers. For example, let the largest address range of any of the switch complexes using non-transparent ports be 0 to M−1 bytes. Then the transparent port of each of the lowest level of switch will also be 0 to M−1 bytes, while the address range of the non-transparent ports will be M to 2M−1, with an offset of −M applied to the addresses of requests that map to the non-transparent port. Similarly, the next level of switches will have a transparent port range of 0 to 2M−1 bytes, and the non-transparent range will be 2M to 4M−1 with an offset of −2M. As with the lower switch level, the lowest 0 to M−1 address map to the microprocessor complex serving as the root complex of the tree which owns the switch, while the M to 4M−1 all map to a non-transparent port at one or the other or both of the levels of the switch.

When “L” is defined as the level number of the switch, and with L=1 the level closest to the microprocessor complexes, then at each level thereafter the transparent port covers a range of 0 to L*M−1, while the non-transparent port covers a range of L*M to 2*L*M−1, with an offset of −L*M. A dual ported I/O router essentially adds an additional level of switches for that particular I/O device. Based on these assignments and the actual switch connectivity, a static map of address ranges to microprocessor complexes can be produced for each switch tree. Then, when setting up an I/O router or HBA (I/O device) to microprocessor complex direct memory access transfer, i.e. a data path, the destination and owning microprocessor complex numbers are simply used to index a table of direct memory access address offsets that are added to the local address of the allocated buffers as shown in Table 1.

TABLE 1
Table of Address offsets for two level switch configuration.

Destination Cplx

| Owner Cplx | 1 | 2 | 3 | 4 |
|---|---|---|---|---|
| 1 | 0 | 2M | 3M | 1M |
| 2 | 2M | 0 | 1M | 3M |
| 3 | 3M | 1M | 0 | 2M |
| 4 | 1M | 3M | 2M | 0 |

Thus, using the techniques discussed here, an address mapping table can easily be developed for any size cross-coupled system of switches with non-transparent ports coupled to multiple ported I/O routers. In one embodiment, the tables would be derived during boot up with relevant information programmed into the switches at that time. In another embodiment of the present invention, the information would be saved for each microprocessor complex, so it could immediately translate a destination complex plus local memory address into the correct offset memory address for that complex's devices, thus enabling efficient and rapid communication from any I/O device to any microprocessor complex in the system.

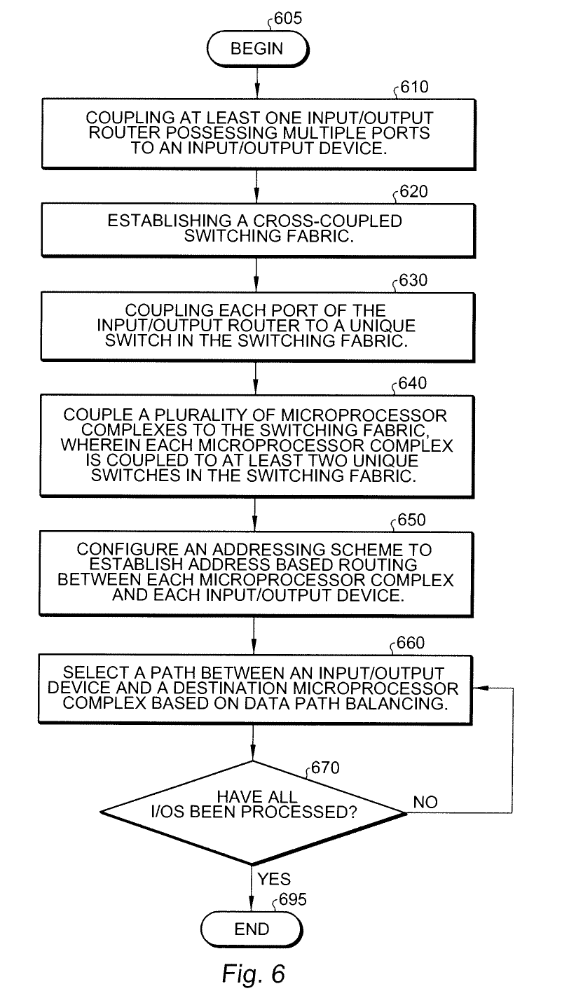

FIG. 6 is a flow chart of one method embodiment for providing multiple data paths between a plurality of I/O devices and a plurality of microprocessor complexes using a cross-coupled switching fabric and multiple ported I/O routers, according to the present invention. Multiple data paths are formed by coupling 610 I/O routers having multiple ports to I/O devices. In one embodiment of the present invention dual ported I/O routers are utilized so as to offer each I/O device with a choice of two means by which to connect to a switching fabric. The switching fabric is established 620 by cross-coupling a plurality of switches. In another embodiment of the present invention peripheral component interconnect express switches are cross-coupled using non-transparent ports to form the switching fabric. Each port of the I/O router is coupled 630 to unique switch in the switching fabric.

Switches within the switching fabric are further coupled 640 to plurality of microprocessor complexes wherein each microprocessor complex is coupled to at least two unique switches of the switching fabric. The resulting network of switches and I/O routers produces multiple redundant paths between each I/O device and each microprocessor complex.

An address scheme is configured 650 to establish an address based routing or map between each microprocessor complex and each I/O device. From these multiple paths or routes, a select data path is selected 660 based, in one embodiment of the present invention, on data path balancing. A query 670 is then performed to determine if all of the I/O associated with the processing is complete. When the I/O is complete the process terminates 695. When additional I/O is ongoing, path selection 660 is again conducted.

While I/O routers having a plurality of ports provide a plurality of options for balancing data traffic as well as switch and microprocessor complex utilization, such I/O routers with multiple ports also improve system availability. In another embodiment of the present invention, a scheme allows both single and dual ported I/O devices to co-exist in the same I/O chassis. This configuration provides maximum configuration flexibility without limiting the capability of single ported systems. In yet another embodiment of the present invention, single ported I/O cards are interleaved with dual ported I/O routers.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies and other aspects are not mandatory or significant, and the mechanisms that implement the invention or its features may have different names, divisions and/or formats. Furthermore, as will be apparent to one of ordinary skill in the relevant art, the modules, managers, functions, systems, engines, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment and can be stored on any applicable storage media or medium that can possess program code. Accordingly, the disclosure of the present invention is intended to be illustrative, but not limiting, of the scope of the invention.

While there have been described above the principles of the present invention in conjunction with specific computer architecture, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserve the right to formulate new claims to such features and/or combinations of such features during the prosecution of the present application or of any further application derived therefrom.

We claim:

1. A system for providing redundant paths between each of a plurality of Input/Output (“I/O”) devices and each of a plurality of microprocessor complexes, the system comprising:
an I/O router coupled to at least one of the plurality of I/O devices wherein the I/O router includes two or more internal ports;
a cross-coupled switching fabric comprising a plurality of switches wherein the I/O router is coupled to at least two of the plurality of switches of the cross-coupled switching fabric and wherein each microprocessor complex is coupled to at least two of the plurality of switches; and
an addressing scheme configured to establish address based routing between each of the plurality of microprocessor complex and each of the plurality of I/O devices.

2. The system of claim 1, wherein the I/O router is configured to select a path between the I/O device coupled to the I/O router and a destination microprocessor complex.

3. The system of claim 2, wherein the I/O router selects the path between the I/O device and the destination microprocessor complex based on balancing data traffic.

4. The system of claim 1, further comprising at least two single ported host bus adapters wherein each single ported host bus adapter couples a single I/O device to at least two different switches in the cross-coupled switching fabric.

5. The system of claim 4, wherein the at least two single ported host bus adapters are network interconnect cards.

6. The system of claim 1, wherein the cross-coupled switching fabric is comprised of peripheral component interconnect express switches.

7. The system of claim 6, wherein each peripheral component interconnect express switch includes at least one transparent port configured to provide at least two paths between each of the plurality of I/O devices and each of the plurality of microprocessor complexes.

8. The system of claim 6, wherein the peripheral component interconnect express switches are cross-coupled via non-transparent ports.

9. The system of claim 1, wherein the addressing scheme creates a static address routing map between each of the plurality of microprocessor complexes and each of the plurality of I/O devices.

10. A computer implemented method for providing redundant paths between each of a plurality of Input/Output (“I/O”) devices and each of a plurality of microprocessor complexes, comprising:
coupling at least one I/O router to an I/O device wherein each I/O router includes two or more internal ports;
establishing a cross-coupled switching fabric comprising a plurality of switches wherein each I/O router is coupled to at least two of the plurality of switches comprising the cross-coupled switching fabric, and wherein each microprocessor complex is coupled to at least two of the plurality of switches comprising the cross-coupled switching fabric; and
configuring an addressing scheme to establish address based routing between each of the plurality of microprocessor complexes and each of the plurality of I/O devices.

11. The computer implemented method of claim 10, further comprising configuring the I/O router to select a path between each I/O device coupled to that I/O router and a destination microprocessor complex.

12. The computer implemented method of claim 11, wherein the I/O router selects the path between the I/O device and the destination microprocessor complex based on balancing data traffic.

13. The computer implemented method of claim 10, further comprising coupling at least one I/O device to at least two different switches in the cross-coupled switching fabric via at least two single ported host bus adapters, wherein the at least one I/O router and the at least two single ported host bus adapters are interleaved.

14. The computer implemented method of claim 13, wherein the at least two single ported host bus adapters are network interconnect cards.

15. The computer implemented method of claim 10, wherein the cross-coupled switching fabric comprises a plurality of peripheral component interconnect express switches.

16. The computer implemented method of claim 15, wherein each peripheral component interconnect express switch includes at least one transparent port configured to provide at least two paths between each of the plurality of I/O devices and each of the plurality of microprocessor complexes.

17. The computer implemented method of claim 15, wherein the plurality of peripheral component interconnect express switches are cross-coupled via non-transparent ports.

18. The computer implemented method of claim 10, wherein the addressing scheme creates a static address routing map between each of the plurality of microprocessor complexes and each of the plurality of I/O devices.

19. At least one computer-readable medium containing a computer program product for providing redundant paths between each of a plurality of Input/Output (“I/O”) devices and each of a plurality of microprocessor complexes, the computer program product comprising:
program code for coupling each I/O device to either at least one I/O router or at least two host bus adapters wherein each I/O router includes two or more internal ports and each host bus adapter includes a single internal port;
program code for establishing a switching fabric comprising a plurality of peripheral component interconnect express switches cross-coupled via non-transparent ports, wherein each port associated with a particular I/O device is coupled to a different peripheral component interconnect express switch of the plurality of peripheral component interconnect express switches comprising the switching fabric, and wherein each microprocessor complex is coupled to at least two of the plurality of peripheral component interconnect express switches comprising the switching fabric; and
program code for configuring an addressing scheme to establish address based routing between each of the plurality of microprocessor complex and each of the plurality of I/O devices.

20. The computer program product of claim 19, wherein the at least one I/O router selects a path between the I/O device and a destination microprocessor complex based on balancing data traffic.
